(19) United States
(12) Patent Application Publication
(10) Pub. No.: US 2018/0368369 A1
(43) Pub. Date: Dec. 27, 2018

(54) ANIMAL SAFETY RETENTION APPARATUS

(71) Applicants: Michael GREENE, Angier, NC (US); Gale GREENE, Angier, NC (US)

(72) Inventors: Michael GREENE, Angier, NC (US); Gale GREENE, Angier, NC (US)

(21) Appl. No.: 15/658,782

(22) Filed: Jul. 25, 2017

Related U.S. Application Data
(63) Continuation-in-part of application No. 15/630,904, filed on Jun. 22, 2017, now abandoned.

(51) Int. Cl. A01K 15/04; A01K 27/00

(52) U.S. Cl. CPC A01K 15/04; A01K 27/001

(57) ABSTRACT

An animal safety retention apparatus includes a base collar member, at least one protrusion member, and a leash ring member. The base collar member defines a first end and an opposing second end, and a circumferential length of the base collar member e extends therebetween. The at least one protrusion member is operably engaged with the base collar member and extends radially outward from the base collar member.

### BACKGROUND

### Field of the Disclosure

The present disclosure relates generally to a safety device for an animal, and more particularly, to an animal retention safety device, such as a collar, for preventing an animal from traversing an opening, such as through spacing defined by a fence.

### Description of Related Art

Animal retention safety devices designed to prevent an animal from traversing openings, such as through a spacing defined by fence posts, underneath furniture, and/or any other opening that one desires to exclude animals from traversing, include conical collars that are cumbersome. Another typical animal retention device includes animal harnesses that includes a rod which extends laterally across the width of the animal body and tangentially to the harness. Another example animal retention device includes an inflatable horseshoe-shaped pillow that partially surrounds the animal neck. These pillows may easily become deflated thereby allowing the animal to traverse the opening undesirably.

Therefore, it is readily apparent that there is a recognized unmet need for an animal retention system, wherein at least one advantage of such an apparatus may include placing the animal retention system upon an animal while still allowing a user to operably engage a leash with the animal retention system.

### BRIEF SUMMARY

Example implementations of the present disclosure are directed to an improved device and method for preventing an animal from traversing various openings, such as an opening defined by adjoining fence posts. In one aspect, an animal safety retention apparatus may include a base collar member. The base collar member may have a first end and an opposing second end. Additionally, the base collar member may have a circumferential length that extends between the first end and the opposing second end. The animal safety retention apparatus may further include at least one protrusion member that is operably engaged with the base collar member. The at least one protrusion member may extend radially outward from the base collar member. In some aspects, the animal safety retention apparatus may further include a leash ring member. The leash ring member may be configured to operably engage a leash, lead, chain, rope, and/or the like.

In some aspects, the animal safety retention apparatus may further include a coupling element configured to operably engage the first end of the base collar member with the opposing second end of the base collar member. Further, the coupling element may be configured, in conjunction with the base collar member, to form a closed loop.

According to another aspect, the animal safety retention apparatus may further include a plurality of protrusion members. Each of the protrusion members may extend radially outward from the base collar member along the same radial plane. In some aspects, the animal safety retention apparatus may further include a plurality of protection elements. For example, each of the protection elements may be operably engaged with a respective protrusion member. Additionally or alternatively, the animal safety retention apparatus may include an outer collar member that is operably engaged with each of the plurality of protrusion members. In some aspects, the at least one protrusion member may be integrally formed with the base collar member.

According to one example aspect, the base collar member may define a circumferential length and a width. Further, a circumferential stiffness of the base collar member along the circumferential length of the base collar member may be greater than a width stiffness of the base collar member along the width of the base collar member. In some aspects, the base collar member may include a composite fiber material. In another aspect, the base collar member may include a metallic material. In one example aspect, the width of the base collar member may be greater than a diameter of the at least one protrusion element. Additionally, the at least one protrusion element may define a plurality of peaks and valleys extending along a circumferential length of the at least one protrusion member.

In some aspects of the present disclosure, the leash ring may be operably engaged with the base collar member. According to one aspect, the leash ring may be integrally formed with the base collar member. In yet another aspect, the leash ring may be operably engaged with the coupling element. Additionally or alternatively, the leash ring may be integrally formed with the coupling element.

The features, functions and advantages discussed herein may be achieved independently in various example implementations or may be combined in yet other example implementations further details of which may be seen with reference to the following description and drawings.

### BRIEF DESCRIPTION OF THE DRAWING(S)

Having thus described example implementations of the disclosure in general Willis, reference will now be made to the accompanying drawings, which are not necessarily drawn to scale, and wherein:

FIG. 1 illustrates a front view of an animal safety retention apparatus according to one example implementation of the present disclosure;

FIG. 2 illustrates a top perspective view of an animal safety retention apparatus according to one example implementation of the present disclosure;

FIG. 3 illustrates a front cross-sectional view of the animal safety retention apparatus illustrated in FIGS. 1 and 2 according to one example implementation of the present disclosure;

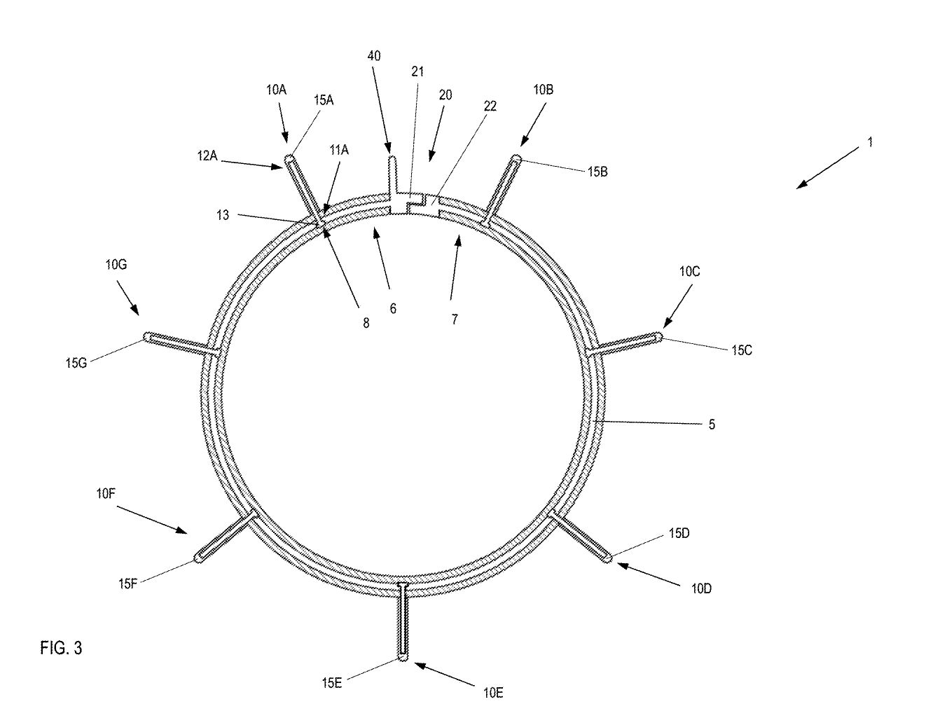

FIG. 4 illustrates a front cross-sectional view of the animal safety retention apparatus according to one example implementation of the present disclosure;

FIG. 5 illustrates a top perspective view of an animal safety retention apparatus according to one example implementation of the present disclosure;

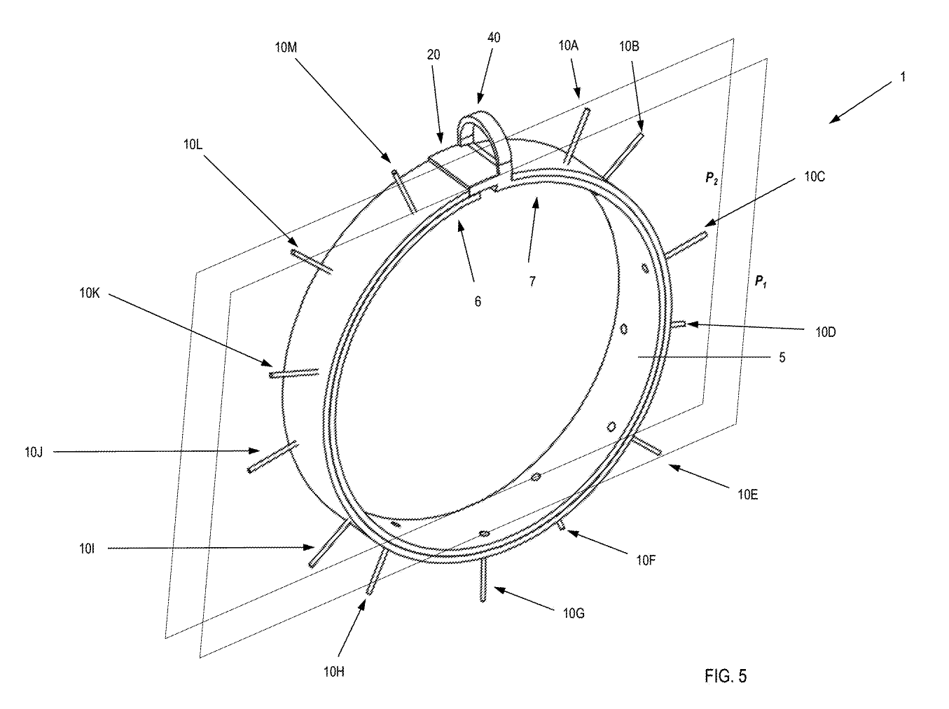

FIG. 6 illustrates a perspective view of an animal safety retention apparatus according to one example implementation of the present disclosure;

FIG. 7 illustrates a perspective view of an animal safety retention apparatus according to one example implementation of the present disclosure;

FIG. 8 illustrates a perspective view of an animal safety retention apparatus according to one example implementation of the present disclosure; and

FIG. 9 illustrates a perspective view of an animal safety retention apparatus according to one example implementation of the present disclosure; and

FIG. 10 illustrates a front cross-sectional view of the animal safety retention apparatus illustrated in FIG. 9 according to one example implementation of the present disclosure.

### DETAILED DESCRIPTION

Some implementations of the present disclosure will now be described more fully hereinafter with reference to the accompanying drawings, in which some, but not all implementations of the disclosure are shown. Indeed, various implementations of the disclosure may be expressed in many different forms and should not be construed as limited to the implementations set forth herein; rather, these exemplary implementations are provided so that this disclosure will be thorough and complete, and will fully convey the scope of the disclosure to those skilled in the art. As used herein, the term “and/or” and the “I” symbol includes any and all combinations of one or more of the associated listed items. Further, unless otherwise indicated, something being described as being a first, second or the like should not be construed to imply a particular order. It should be understood that the terms first, second, etc. may be used herein to describe various steps, calculations, positions and/or the like, these steps, calculations or positions should not be limited to these terms. These terms are only used to distinguish one operation, calculation, or position from another. For example, a first position may be termed a second position, and, similarly, a second step may be termed a first step, without departing from the scope of this disclosure. Additionally, something may be described as being above something else (unless otherwise indicated) may instead be below, and vice versa; and similarly, something described as being to the left of something else may instead be to the right, and vice versa. As used in the specification, and in the appended claims, the singular forms “a”, “an”, “the”, include plural referents unless the context clearly dictates otherwise. Like reference numerals refer to like elements throughout.

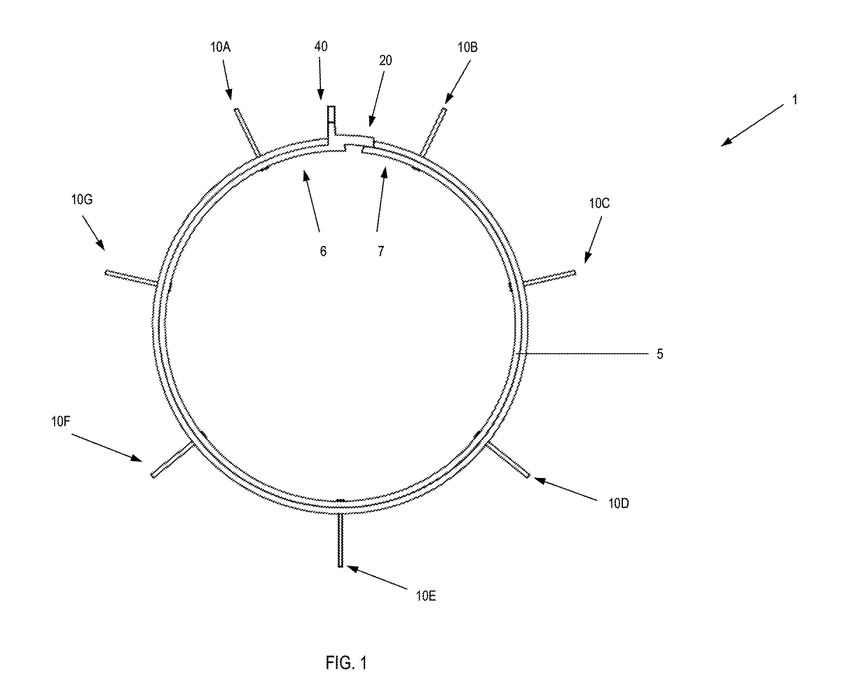

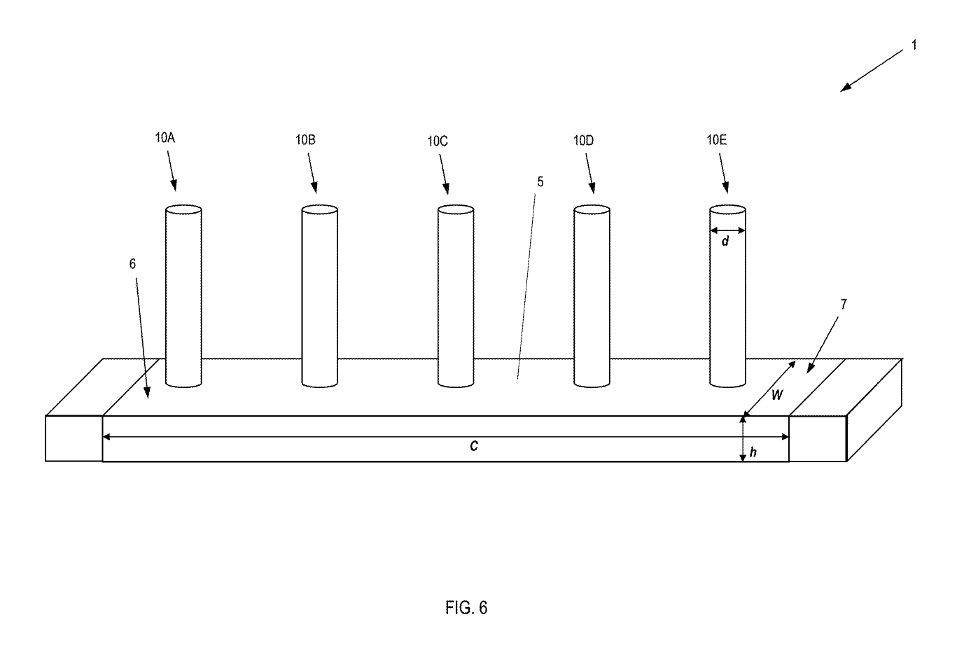

Implementations of the present disclosure provide for an animal safety retention apparatus configured to prevent an animal from traversing an opening, such as a spacing between fence posts. As shown in FIG. 1, an animal safety retention apparatus 1 includes a base collar member 5 that extends from a first end 6 to an opposing second end 7. Referring to FIG. 6, the base collar member 5 defines a circumferential length C that extends between the first end 6 and the opposing second end 7 of the base collar member 5. Additionally, the base collar member 5 defines a width W that extends orthogonally to the circumferential length C of the base collar member 5. Returning to FIG. 1, the animal safety retention apparatus 1 may further include at least one protrusion member 10a that is operably engaged with the base collar member 5. For example, the base collar member 5 may define an aperture configured to receive at least a portion of the protrusion member 10a therethrough. For example, the protrusion member 10a may define a proximal end 11a and an opposing distal end 12a, and the proximal end 11a of the protrusion member 10a may include a flange portion 13 configured to operably engage the base collar member 5 so as to prevent the protrusion member 10a from extending completely through the aperture defined by the base collar member 5. According to one aspect, the at least one protrusion member 10a may be integrally formed with the base collar member 5.

According to one aspect, the base collar member 5 may include any suitable material to provide for particular structural properties of the base collar member 5. For example, an elastic modulus of the base collar member 5 may be uniform throughout the base collar member 5. In another aspect, an elastic modulus of the base collar member 5 may vary throughout portions of the base collar member 5. Additionally or alternatively, the torsional modulus of the base collar member 5 may be uniform throughout the base collar member 5. According to some aspects, the torsional modulus of the base collar member 5 may vary throughout portions of the base collar member 5.

Further, the stiffness and/or rotational stiffness of the base collar member 5 measured with respect to the circumferential length C of the base collar member 5 may differ from the stiffness and/or rotational stiffness of the base collar member 5 measured with respect to the width W of the base collar member 5. For example, the stiffness of the base collar member 5 taken along the circumferential length C (i.e., a circumferential stiffness) may be measured as

$${k}_{c} = \frac{{A}_{c} E}{{L}_{c}} \qquad Eq . 1$$

where A_{c} is the cross-sectional area of the base collar member 5 as defined by the length C and the height h of the base collar member 5, as shown in FIG. 6; E is the elastic modulus of the base collar member 5; and L_{c} is the circumferential length C. In another aspect, the stiffness of the base collar member 5 taken with respect to the width W of the base collar member 5 may be measured as

$${k}_{w} = \frac{{A}_{w} E}{{L}_{w}} \qquad Eq . 2$$

wherein A_{w} is the cross-sectional area of the base collar member 5 as defined by the width w and the height h of the base collar member 5, as shown in FIG. 6; E is the elastic modulus of the base collar member 5; and L_{w} is the width w. Similarly, one of ordinary skill in the art may appreciate that a rotational stiffness of the base collar member 5 measured along the circumferential length C may be different than a rotational stiffness of the base collar member 5 measured along the width w of the base collar member 5. For example, the stiffness and/or rotational stiffness of the base collar member 5 when measured with respect to width w of the base collar member 5 may be greater than the stiffness and/or rotational stiffness of the base collar member 5 when measured with respect to the circumferential length C of the base collar member 5. Accordingly, the stiffness and/or rotational stiffness of the base collar member 5 when measured with respect to the width w of the base collar member 5 is sufficient to prevent displacement of the at least one protrusion member 10a, for example, along a direction parallel to the width w of the base collar member 5. According to one example aspect, the base collar member 5 may include a composite fiber material, such as non-woven fibers impregnated with a thermoplastic resin. In another aspect, the base collar member 5 may include a metallic material, such as aluminum, steel, and/or any suitable alloys.

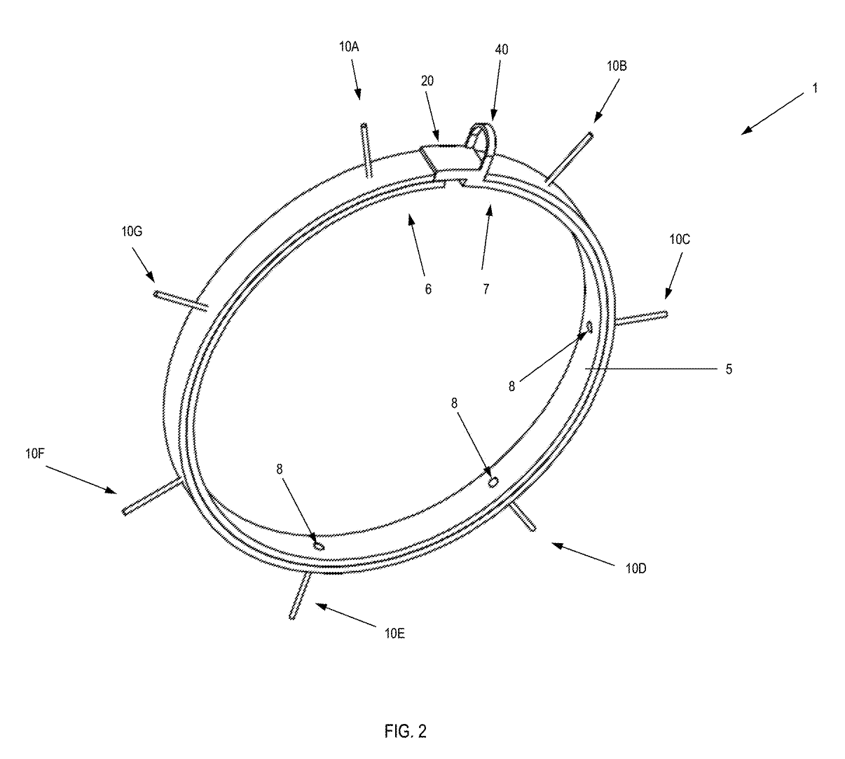

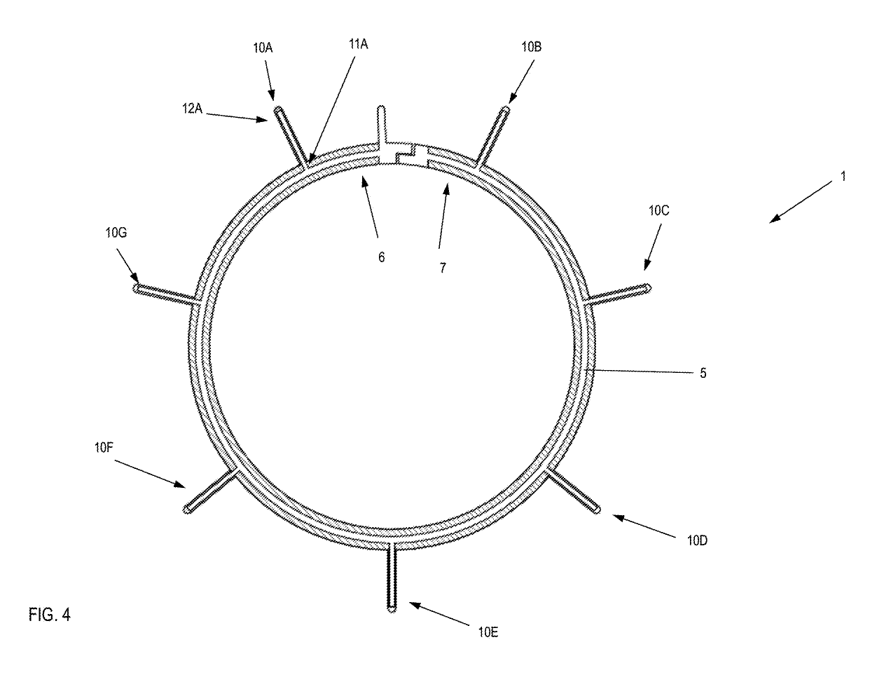

Returning to FIG. 1, the at least one protrusion member 10a may extend radially outward from the base collar member 5. According to one aspect, an animal safety retention apparatus 1 may include a plurality of protrusion members 10a, 10b, 10c . . . , 10n, as shown in FIGS. 1 and 2. In some aspects, the plurality of protrusion members 10a, 10b, 10c . . . , 10n may include similar materials as the base collar member 5. According to one aspect, the plurality of protrusion members 10a, 10b, 10c . . . , 10n may be integrally formed with the base collar member 5, as shown in FIG. 4. According to some aspects, the at least one protrusion member 10a may define a diameter d, as shown in FIG. 6. The diameter d of the at least one protrusion member 10a may be smaller than the width w of the base collar member 5.

According to one aspect, the at least one protrusion member 10a may extend radially outward from the base collar member 5. As shown in FIG. 4, a plurality of protrusion members 10a, 10b, 10c . . . , 10n extend radially outward from the base collar member 5 along the same plane P. In another aspect, a first set of protrusion members 10a, 10c, 10e . . . , 10m may extend radially outward from the base collar member 5 along a first plane P₁ and a second set of protrusion members 10b, 10d, 10f . . . , 10n may extend radially outward from the base collar member 5 along a second plane P₂, which is coplanar to the first plane P₁. In some aspects, as shown in [FIG. X], the first plane P₁ may be offset from the second plane P₂ along the width w of the base collar member 5.

According to some aspects, the animal safety retention apparatus 1 may further include at least one protection element 12a. In some aspects, the animal safety retention apparatus 1 may include a plurality of protection elements 15a, 15b, 15c . . . , 15n that are configured to operably engage a respective protrusion member 10a, 10b, 10c . . . , 10n, as shown in FIG. 4. For example, the at least one protection element 15a may define a cavity configured to reciprocally engage a respective protrusion member 15a in a friction fit, snap fit, and/or the like. The at least one protection element 15a may include a polymer material configured to protect the respective protrusion member 10a from damage. For example, the protection element 15a may be configured to disperse an impact force when the protrusion member 10a and/or the protection element 15a collides with another object (e.g., a fence post).

Returning to FIG. 1, the animal safety retention apparatus 1 may further include a coupling element 20 configured to operably engage a first end 6 of the base collar member 5 with an opposing second end 7 of the base collar member 5. For example, the coupling element 20 may include reciprocally-engaging buckle members securely affixed to the first and opposing second end 6,7 of the base collar member 5 respectively. For example, the coupling element 20 may include a first coupling member 21 disposed proximate the first end 6 of the base collar member 5. Further, the coupling element 20 may include a second coupling member 22 disposed proximate the second end 7 of the base collar member 5. According to some aspects, the first coupling member 21 and the second coupling member 22 may be configured to reciprocally engage one another so as to secure the first coupling member 21 with the second coupling member 22. In some aspects, the coupling element 20 may be integrally formed with the base collar member 5.

Additionally, the animal safety retention apparatus 1 may further include a leash ring member 40, as shown in FIG. 1. In some aspects, the leash ring member 40 may be operably engaged with the base collar member 5. Alternatively, the leash ring member 40 may be integrally formed with the base collar member 5. In some aspects, the leash ring member 40 may be operably engaged with the coupling element 20. For example, the leash ring member 40 may be operably engaged with one of the first or second coupling members 21, 22. Alternatively, the leash ring member 40 may be integrally formed with the coupling element 20. For example, the leash ring member 40 may be integrally formed with one of the first or second coupling members 21, 22.

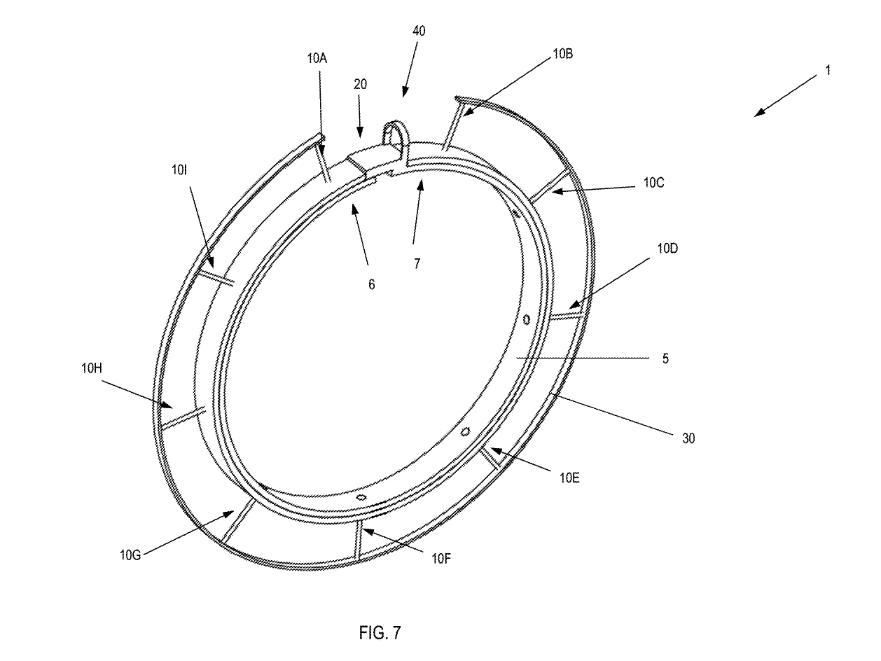

In some aspects, the animal safety retention apparatus may further include an outer collar member 30 operably engaged with each of the plurality of protrusion members, as shown in FIG. 7. For example, the outer collar member 30 may be operably engaged with each of the distal ends 12a, 12b, 12c . . . , 12n of the plurality of protrusion members 10a, 10b, 10c . . . , 10n. In some aspects, the outer collar member 30 may be integrally formed with each of the protrusion members 10a, 10b, 10c . . . , 10n. Accordingly, the outer collar member 30 may be shaped so as to have a greater circumference than the base collar member 5.

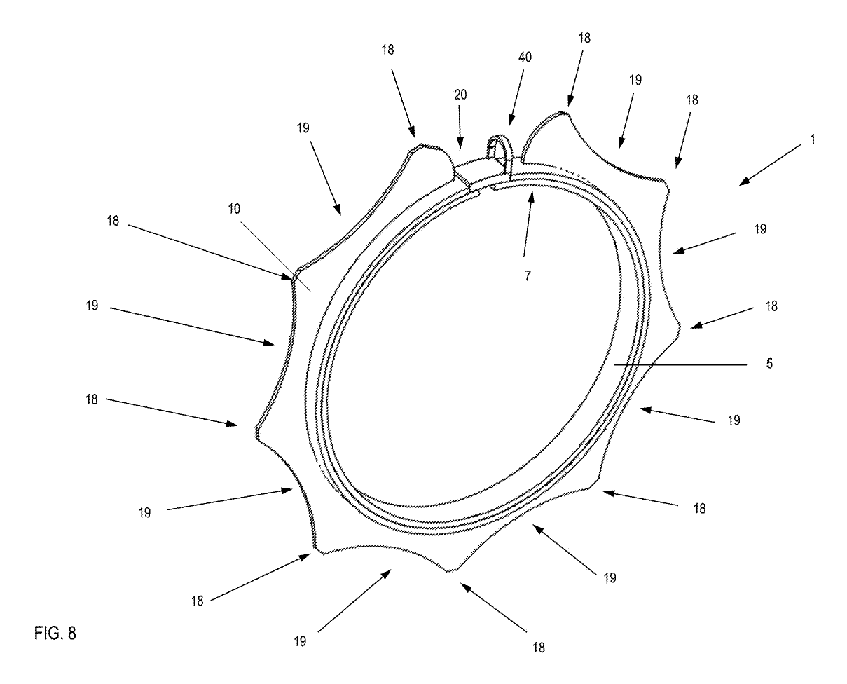

In some aspects, the at least one protrusion member 10 may extend radially outward from the base collar member 5 with varying lengths. For example, as shown in FIG. 8, the at least one protrusion member 10 may define a plurality of peaks 18 and valleys 19 that extend along the distal end 12 of the at least one protrusion member 10 along the circumference of the protrusion member 10.

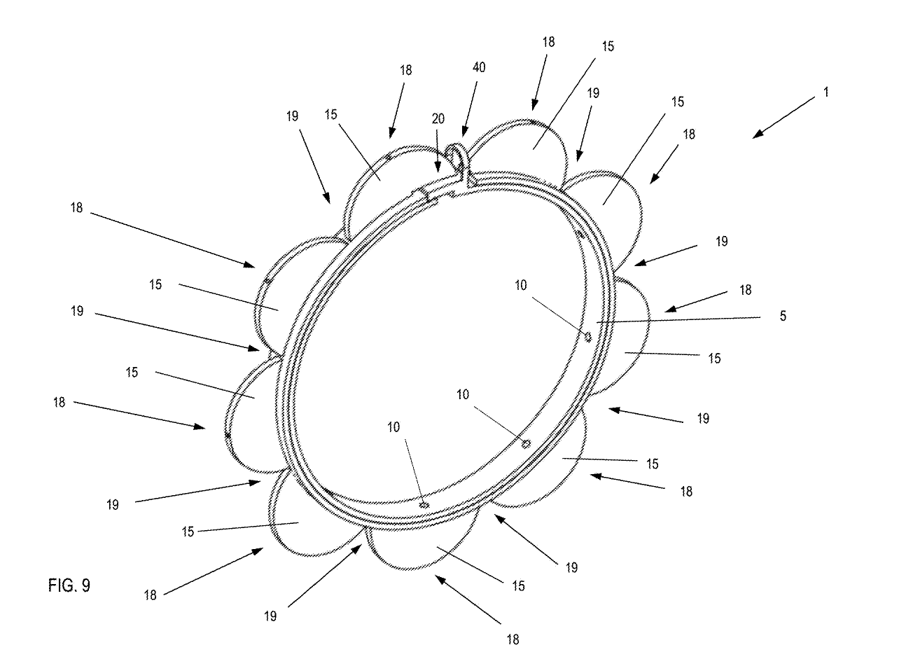

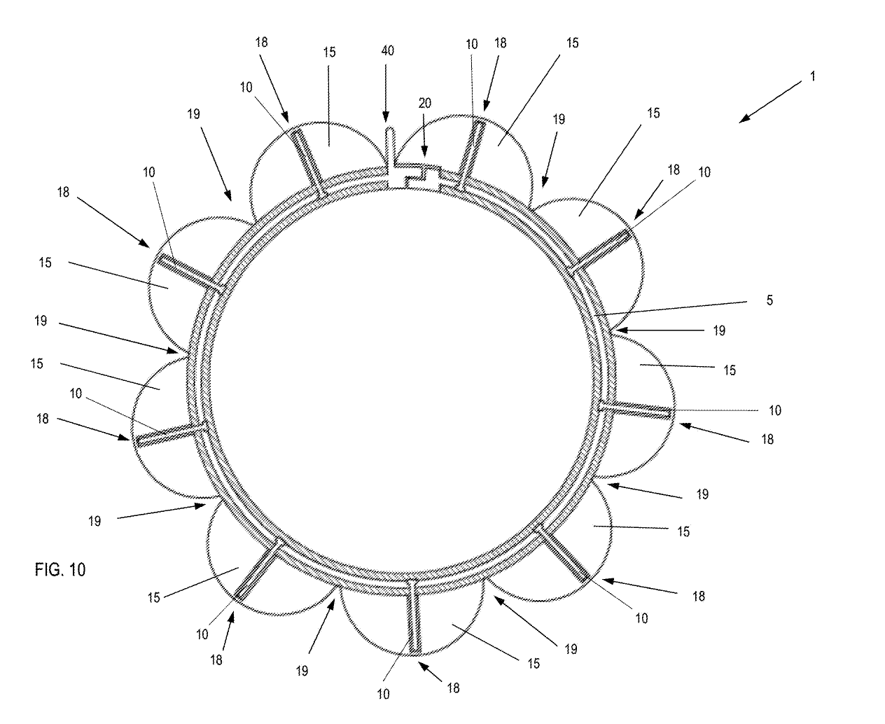

According to another aspect, the animal safety retention apparatus 1 may include a plurality of protection elements 15a, 15b, 15c . . . , 15n that operably engage a respective protrusion members 10a, 10b, 10c . . . , 10n, as shown in FIGS. 9 and 10. In particular, a first protection element 15a and a subsequent protection element 15b may be configured to define a plurality of peaks 18 and valleys 19 that extend along the circumference of the animal safety retention apparatus 1. In another aspect, a single protection element 15 may be configured to operably engage each of the protrusion elements 10 and define a plurality of peaks 18 and valleys 19 that extend along the circumference of the animal safety retention apparatus 1. In yet another example implementation of the present disclosure, the animal safety retention apparatus may include a plurality of electronics (e.g., laser emitting diodes, global positioning system tracking devices, etc.) configured to provide additional functionality and advantages.

Many modifications and other implementations of the disclosure set forth herein will come to mind to one skilled in the art to which the disclosure pertains having the benefit of the teachings presented in the foregoing description and the associated drawings. Therefore, it is to be understood that the disclosure is not to be limited to the specific implementations disclosed and that modifications and other implementations are intended to be included within the scope of the appended claims. Moreover, although the foregoing description and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An animal safety retention apparatus comprising:
a base collar member, the base collar member having a circumferential length, the base collar member having a first end and an opposing second end, the circumferential length extending therebetween;
at least one protrusion member operably engaged with and extending radially outward from the base collar member; and
a leash ring member.

2. The apparatus of claim 1 further comprising a coupling element configured to operably engage the first end of the base collar member with the second end of the base collar member.

3. The apparatus of claim 1 further comprising a plurality of protrusion members, wherein each of the protrusion members extend radially outward from the base collar member along the same radial plane.

4. The apparatus of claim 3 further comprising a plurality of protection elements, wherein each of the protrusion members are operably engaged with a respective protection element.

5. The apparatus of claim 3 further comprising an outer collar member, the outer collar member operably engaged with each of the plurality of protrusion members.

6. The apparatus of claim 1 wherein the at least one protrusion member is integrally formed with base collar member.

7. The apparatus of claim 1 wherein the base collar member defines a circumferential length and a width, wherein a circumferential stiffness of the base collar member along the circumferential length of the base collar member is greater than a width stiffness of the base collar member along the width of the base collar member.

8. The apparatus of claim 7, wherein the base collar member comprises a composite fiber material.

9. The apparatus of claim 7, wherein the base collar member comprises a metallic material.

10. The apparatus of claim 1, wherein the leash ring member is operably engaged with the base collar member.

11. The apparatus of claim 10, wherein the leash ring member is integrally formed with the base collar member.

12. The apparatus of claim 2, wherein the leash ring member is operably engaged with the coupling element.

13. The apparatus of claim 12, wherein the leash ring member is integrally formed with the coupling element.

14. The apparatus of claim 1, wherein the base collar member defines a circumferential length and a width, wherein the width of the base collar member is greater than a diameter of the at least one protrusion member.

15. The apparatus of claim 6, wherein the at least one protrusion member defines a plurality of peaks and valleys extending along a circumferential length of the protrusion member.
